(19) United States
(12) Patent Application Publication
(10) Pub. No.: US 2018/0081762 A1
(43) Pub. Date: Mar. 22, 2018

(54) INFORMATION PROCESSING DEVICE

(71) Applicants: Kabushiki Kaisha Toshiba, Minato-ku, Tokyo (JP); Toshiba Infrastructure Systems & Solutions Corporation, Kawasaki-shi, Kanagawa (JP)

(72) Inventor: Atsushi INOUE, Fuchu Tokyo (JP)

(21) Appl. No.: 15/558,075

(22) PCT Filed: Dec. 18, 2015
(86) PCT No.: PCT/JP2015/085556

§ 371 Date: Sep. 13, 2017

(30) Foreign Application Priority Data
Mar. 23, 2015 (JP) 2015-060035

(51) Int. Cl. G06F 11/14; G05B 23/02; G06F 11/07

(52) U.S. Cl. CPC G06F 11/1438; G05B 23/0259; G06F 2201/805; G06F 11/079; G06F 11/0751

(57) ABSTRACT

An information processing device according to embodiments includes a hardware, a control unit, a detector, a disconnection unit, a diagnosis unit, and a processor. The disconnection unit disconnects a connection between the hardware and the control unit in a case where an abnormality is detected in the control unit and first processing is not carried out by the control unit. The diagnosis unit carries out second processing of detecting an abnormality in the hardware in a case where the connection between the hardware and the control unit is disconnected. The processor carries out third processing of recording a result of the second processing to a second storage.

### FIELD

Embodiments of the present invention relate to an information processing device.

### BACKGROUND

A control unit such as a central processing unit (CPU) built into an information processing device such as a controller in a plant cancels a reset signal from a reset circuit to start up and thereafter, retrieves a program from a non-volatile memory to load the retrieved program into a working memory, thereby carrying out various actions including control of hardware. Additionally, the information processing device has a watch doc timer that detects an abnormality in the control unit and outputs an interrupt signal to the control unit. Once the interrupt signal is input to the control unit from the watch doc timer, the control unit carries out diagnosis processing on the hardware and then records a result of this diagnosis processing to the non-volatile memory.

### CITATION LIST

### Patent Literature

Patent Literature 1: JP 10-124141 A

### SUMMARY OF THE INVENTION

### Problem to be Solved by the Invention

Incidentally, in a case where an abnormality occurs in the control unit due to a noise temporarily superimposed on the reset signal input to the control unit from the reset circuit, the control unit is brought down before the interrupt signal is input thereto from the watch doc timer. As a result, the diagnosis processing cannot be carried out and a result of this diagnosis processing also cannot be recorded. In this case, it is difficult to locate a cause of an abnormal shutdown of the information processing device even if the retrieval of the result of the diagnosis processing stored in the non-volatile memory is attempted after the information processing device restarts, because the result of the diagnosis processing is not stored therein.

### Means for Solving Problem

An information processing device according to embodiments includes hardware, a control unit, a detector, a disconnection unit, a diagnosis unit, and a processor. The control unit is communicably connected to the hardware and carries out startup processing of starting up in accordance with a first reset signal that has been input to the control unit and first processing of detecting an abnormality in the hardware and then recording a result of abnormality detection in the hardware to a first storage. The detector carries out processing of detecting an abnormality in the control unit and, in a case where an abnormality is detected in the control unit, causes the control unit to carry out the first processing. The disconnection unit disconnects a connection between the hardware and the control unit in a case where an abnormality is detected in the control unit and the first processing is not carried out by the control unit. The diagnosis unit carries out second processing of detecting an abnormality in the hardware in a case where the connection between the hardware and the control unit is disconnected. The processor carries out third processing of recording a result of the second processing to a second storage.

### BRIEF DESCRIPTION OF DRAWINGS

FIG. 1 is a block diagram illustrating an exemplary function configuration of a controller according to a first embodiment.

FIG. 2 is a diagram illustrating an exemplary configuration of a log-recording non-volatile memory included in the controller according to the first embodiment.

FIG. 3 is a flowchart illustrating an exemplary flow of first log-recording processing by the controller according to the first embodiment.

FIG. 4 is a flowchart illustrating an exemplary flow of hardware diagnosis processing and second log-recording processing by the controller according to the first embodiment.

FIG. 5 is a block diagram illustrating an exemplary function configuration of a controller according to a second embodiment.

### DETAILED DESCRIPTION

Hereinafter, information processing devices according to embodiments will be described with reference to the accompanying drawings. The following description will exemplify a case where the information processing devices according to the embodiments are applied to a controller (control device) configured to control apparatuses to be controlled in a plant (e.g., a valve and a motor). However, the information processing devices also can be applied to a device other than the controller as long as the device includes a control unit such as a central processing unit (CPU) configured to control hardware.

### First Embodiment

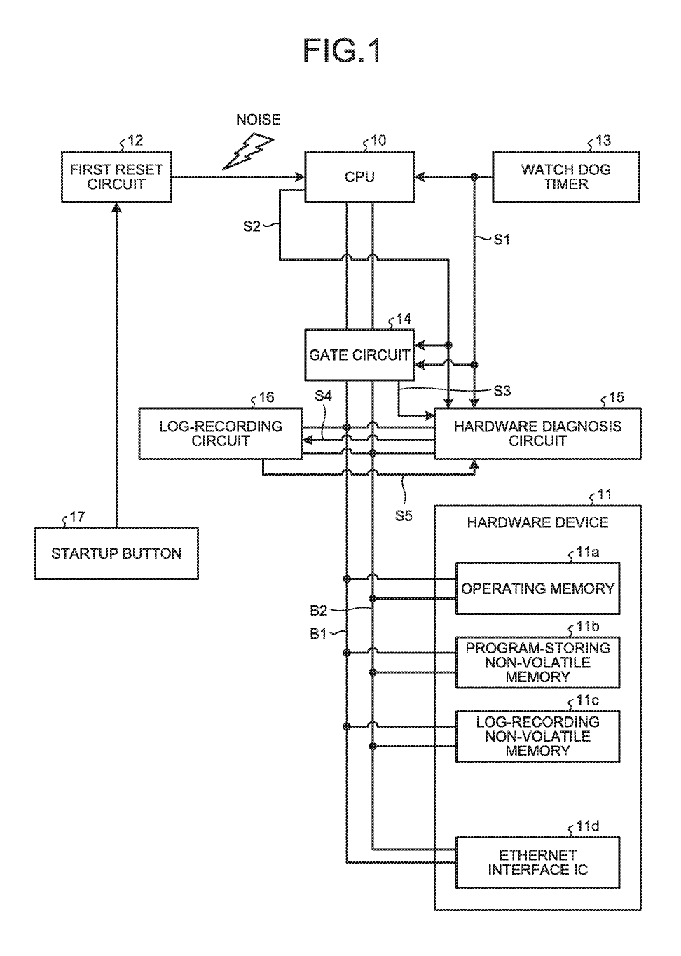

FIG. 1 is a block diagram illustrating an exemplary function configuration of a controller according to a first embodiment. As illustrated in FIG. 1, the controller according to the embodiment has a CPU 10, a hardware device 11, a first reset circuit 12, a watch doc timer 13, a gate circuit 14, a hardware diagnosis circuit 15, a log-recording circuit 16, and a startup button 17.

Upon being pressed by an operator of the controller, the startup button 17 outputs a startup signal instructing a startup of the controller to the first reset circuit 12 described later. Once the startup signal is input to the first reset circuit 12 (an example of a first reset unit) after the startup button 17 is pressed by the operator, the first reset circuit 12 outputs a reset signal (an example of a first reset signal) instructing the execution of startup processing to the CPU 10 and the hardware device 11.

The hardware device 11 includes a plurality of hardware such as an operating memory 11a, a program-storing non-volatile memory 11b, a log-recording non-volatile memory 11c, and an Ethernet (registered trademark) interface IC 11d (hereinafter, simply mentioned as hardware in a case where the operating memory 11a, the program-storing non-volatile memory 11b, the log-recording non-volatile memory 11c, and the Ethernet interface IC 11d do not need to be distinguished from one another). Each of the hardware included in the hardware device 11 carries out the startup processing once the reset signal is input thereto from the first reset circuit 12.

The operating memory 11a is used as a working area when the CPU 10 executes various programs. In the embodiment, the operating memory 11a stores a value set in advance to be used during hardware diagnosis processing for this operating memory 11a (hereinafter, referred to as fixed value). The hardware diagnosis processing (an example of second processing) here represents processing to detect an abnormality in the hardware. The program-storing non-volatile memory 11b stores various programs executed by the CPU 10, a fixed value, and so on. The log-recording non-volatile memory 11c (an example of a storage) stores execution results of various processing procedures by the CPU 10, a result of the hardware diagnosis processing by the hardware diagnosis circuit 15 described later, and a fixed value. According to the embodiment, the fixed values stored in the operating memory 11a, the program-storing non-volatile memory 11b, and the log-recording non-volatile memory 11c may be the same value or different values.

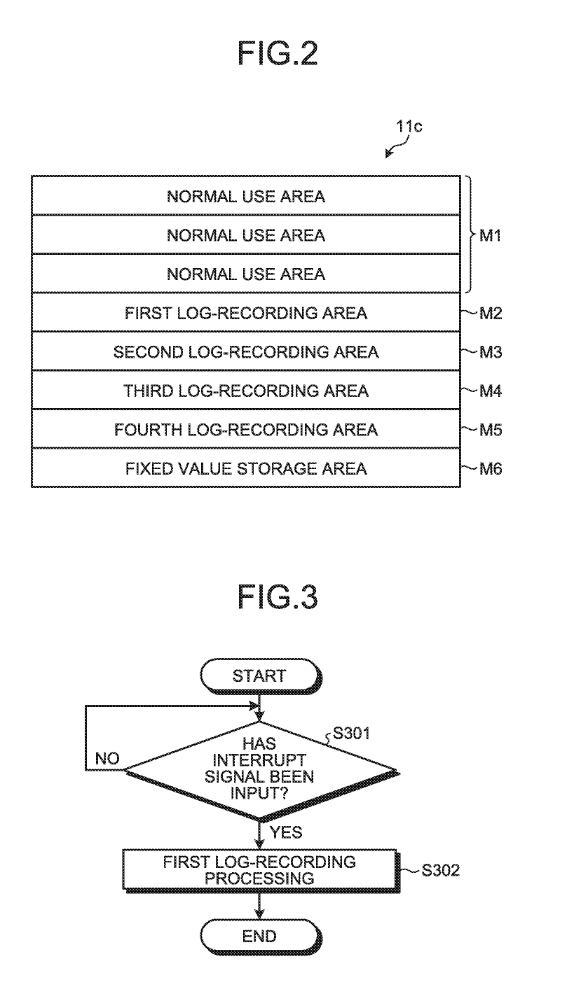

FIG. 2 is a diagram illustrating an exemplary configuration of the log-recording non-volatile memory included in the controller according to the first embodiment. As illustrated in FIG. 2, the log-recording non-volatile memory 11c according to the embodiment has a normal use area M1, a first log-recording area M2, a second log-recording area M3, a third log-recording area M4, a fourth log-recording area M5, and a fixed value storage area M6. Logs of various processing procedures carried out within the controller while no abnormality occurs in the controller are recorded to the normal use area M1.

A result of the hardware diagnosis processing for the program-storing non-volatile memory 11b is recorded to the first log-recording area M2. A result of the hardware diagnosis processing for the operating memory 11a is recorded to the second log-recording area M3. A result of the hardware diagnosis processing for the log-recording non-volatile memory 11c is recorded to the third log-recording area M4. A result of the hardware diagnosis processing for the Ethernet interface IC 11d is recorded to the fourth log-recording area M5. The fixed value storage area M6 is an area storing the fixed value.

Referring back to FIG. 1, the Ethernet interface IC 11d is a communication interface configured to manage communication with an external device in compliance with an Ethernet standard. Although the hardware device 11 according to the embodiment has the plurality of hardware, the hardware device 11 is not limited thereto as long as at least one hardware is included therein.

The CPU 10 is an example of the control unit configured to control the entire controller. The CPU 10 is communicably connected to the respective hardware included in the hardware device 11. In the embodiment, the CPU 10 is connected to the hardware via a data bus B1 to transmit and receive various types of information to and from the hardware via this data bus B1. The CPU 10 is also connected to memories including the operating memory 11a, the program-storing non-volatile memory 11b, and the log-recording non-volatile memory 11c via an address bus B2 to notify the memories of an address of a storage area to be accessed, via the address bus B2.

Meanwhile, the CPU 10 carries out the startup processing to start up in accordance with the reset signal input from the first reset circuit 12 and thereafter, starts control of the hardware. In addition, when an interrupt signal S1 is input to the CPU 10 from the watch doc timer 13 described later, the CPU 10 carries out first log-recording processing (an example of first processing) to detect an abnormality in the hardware and then record a result of abnormality detection in the hardware to the log-recording non-volatile memory 11c (an example of a first storage).

Once the interrupt signal S1 is input to the CPU 10, the CPU 10 according to the embodiment carries out processing of outputting an access signal S2 to the hardware via the data bus B1 and then retrieving the fixed values from the hardware. Subsequently, when the fixed values have been successfully retrieved from the hardware, the CPU 10 determines that no abnormality in the hardware has been detected and then records a flag to the log-recording non-volatile memory 11c. On the other hand, when the fixed values have not been successfully retrieved from the hardware (or correct fixed values have not been retrieved), the CPU 10 determines that an abnormality has been detected in the hardware and therefore, does not record any flag to the log-recording non-volatile memory 11c. In such a manner, the CPU 10 carries out the first log-recording processing of detecting an abnormality in the hardware and then recording a result of abnormality detection.

In the embodiment, the CPU 10 records a result of abnormality detection in the hardware to the log-recording non-volatile memory 11c by whether to record a flag to the log-recording non-volatile memory 11c. However, the CPU 10 is not limited thereto but may record a result of abnormality detection in the hardware by recording, to the log-recording non-volatile memory 11c, a log indicating that an abnormality has been detected in the hardware or a log indicating that no abnormality has been detected in the hardware.

Additionally, in the embodiment, the CPU 10 outputs a first signal notifying that the CPU 10 is normally working to the watch doc timer 13 described later at time intervals set in advance.

The watch doc timer 13 (an example of a detector) carries out processing of detecting an abnormality in the CPU 10 and, when an abnormality in the CPU 10 is detected, outputs an interrupt signal to the CPU 10 to cause this CPU 10 to carry out the first log-recording processing. In a case where no new first signal is received from the CPU 10 even after the time interval set in advance elapses since the last first signal was received therefrom, the watch doc timer 13 according to the embodiment determines that an abnormality has occurred in the CPU 10 and then outputs the interrupt signal S1 to the CPU 10, the gate circuit 14, and the hardware diagnosis circuit 15.

In a case where the interrupt signal S1 has been input from the watch doc timer 13 but the access signal S2 is not output from the CPU 10 to the hardware via the data bus B1 (that is, the first log-recording processing is not carried out by the CPU 10), the gate circuit 14 (an example of a disconnection unit) prohibits communication between the CPU 10 and the hardware via the data bus B1 and the address bus B2. With this, the gate circuit 14 disconnects a connection between the CPU 10 and the hardware. In addition, upon disconnecting the connection between the CPU 10 and the hardware, the gate circuit 14 outputs a gate-closed signal S3 notifying that the connection between the CPU 10 and the hardware has been disconnected to the hardware diagnosis circuit 15.

Once the gate-closed signal S3 is input to the hardware diagnosis circuit 15 (an example of a diagnosis unit) from the gate circuit 14 (that is, the connection between the CPU 10 and the hardware is disconnected), the hardware diagnosis circuit 15 carries out the hardware diagnosis processing on the hardware. In addition, after the hardware diagnosis processing is completed for all of the hardware, the hardware diagnosis circuit 15 terminates the action of the controller.

The log-recording circuit 16 (an example of a processor) carries out second log-recording processing (an example of third processing) to record, to the log-recording non-volatile memory 11c (an example of a second storage), a result of the hardware diagnosis processing carried out by the hardware diagnosis circuit 15. With this, a result of the hardware diagnosis processing can be recorded even in a case where the CPU 10 stops working and an abnormality occurs in the controller due to a noise superimposed on the reset signal input to the CPU 10 from the first reset circuit 12, or the like. Consequently, a cause of the abnormality occurring within the controller can be located by confirming information stored in the log-recording non-volatile memory 11c, even in a case where the abnormality occurs in the CPU 10.

A specific example of the hardware diagnosis processing and the second log-recording processing by the controller according to the embodiment is described here. In the embodiment, once the gate-closed signal S3 is input to the hardware diagnosis circuit 15 from the gate circuit 14, the hardware diagnosis circuit 15 first carries out the hardware diagnosis processing on the log-recording non-volatile memory 11c. Specifically, the hardware diagnosis circuit 15 accesses the fixed value storage area M6 of the log-recording non-volatile memory 11c to carry out retrieval processing for the fixed value from this fixed value storage area M6. In a case where the fixed value has been successfully retrieved from the fixed value storage area M6, the hardware diagnosis circuit 15 determines that no abnormality has been detected in the log-recording non-volatile memory 11c and thus outputs a log-recording start signal S4 to the log-recording circuit 16. On the other hand, when the fixed value has not been successfully retrieved from the fixed value storage area M6 (or a correct fixed value has not been retrieved), the hardware diagnosis circuit 15 determines that an abnormality has been detected in the log-recording non-volatile memory 11c and thus outputs a log-recording prohibition signal to the log-recording circuit 16.

The log-recording circuit 16 records a flag to the third log-storing area M4 of the log-recording non-volatile memory 11c when the log-recording start signal S4 is input thereto. On the other hand, the log-recording circuit 16 does not record a flag to the log-recording non-volatile memory 11c when the log-recording prohibition signal is input thereto. After the recording of the flag to the log-recording non-volatile memory 11c is completed or in a case where the log-recording prohibition signal is input, the log-recording circuit 16 outputs, to the hardware diagnosis circuit 15, a log-recording completion signal S5 indicating that the second log-recording processing has been completed.

The hardware diagnosis circuit 15 subsequently carries out the hardware diagnosis processing on the operating memory 11a once the log-recording completion signal S5 is input thereto. Specifically, the hardware diagnosis circuit 15 accesses the operating memory 11a to carry out the retrieval processing for the fixed value from this operating memory 11a. In a case where the fixed value has been successfully retrieved from the operating memory 11a, the hardware diagnosis circuit 15 determines that no abnormality has been detected in the operating memory 11a and thus outputs the log-recording start signal S4 to the log-recording circuit 16. On the other hand, when the fixed value has not been successfully retrieved from the operating memory 11a (or a correct fixed value has not been retrieved), the hardware diagnosis circuit 15 determines that an abnormality has been detected in the operating memory 11a and thus outputs the log-recording prohibition signal to the log-recording circuit 16.

The log-recording circuit 16 records a flag to the second log-storing area M3 of the log-recording non-volatile memory 11c when the log-recording start signal S4 is input thereto. On the other hand, the log-recording circuit 16 does not record a flag to the log-recording non-volatile memory 11c when the log-recording prohibition signal is input thereto. Once the recording of the flag to the log-recording non-volatile memory 11c is completed or in a case where the log-recording prohibition signal is input, the log-recording circuit 16 outputs the log-recording completion signal S5 to the hardware diagnosis circuit 15.

The hardware diagnosis circuit 15 subsequently carries out the hardware diagnosis processing on the program-storing non-volatile memory 11b once the log-recording completion signal S5 is input thereto. Specifically, the hardware diagnosis circuit 15 accesses the program-storing non-volatile memory 11b to carry out the retrieval processing for the fixed value from this program-storing non-volatile memory 11b. In a case where the fixed value has been successfully retrieved from the program-storing non-volatile memory 11b, the hardware diagnosis circuit 15 determines that no abnormality has been detected in the program-storing non-volatile memory 1b and thus outputs the log-recording start signal S4 to the log-recording circuit 16. On the other hand, when the fixed value has not been successfully retrieved from the program-storing non-volatile memory 11b (or a correct fixed value has not been retrieved), the hardware diagnosis circuit 15 determines that an abnormality has been detected in the program-storing non-volatile memory 11b and thus outputs the log-recording prohibition signal to the log-recording circuit 16.

The log-recording circuit 16 records a flag to the first log-storing area M2 of the log-recording non-volatile memory 11c when the log-recording start signal S4 is input thereto. On the other hand, the log-recording circuit 16 does not record a flag to the log-recording non-volatile memory 11c when the log-recording prohibition signal is input thereto. Once the recording of the flag to the log-recording non-volatile memory 11c is completed or in a case where the log-recording prohibition signal is input, the log-recording circuit 16 outputs the log-recording completion signal S5 to the hardware diagnosis circuit 15.

The hardware diagnosis circuit 15 subsequently carries out the hardware diagnosis processing on the Ethernet interface IC 11d once the log-recording completion signal S5 is input thereto. Specifically, the hardware diagnosis circuit 15 accesses an external device via the Ethernet interface IC 11d to carry out the retrieval processing for the fixed value from this external device. In a case where the fixed value has been successfully retrieved from the external device, the hardware diagnosis circuit 15 determines that no abnormality has been detected in the Ethernet interface IC 11d and thus outputs the log-recording start signal S4 to the log-recording circuit 16. On the other hand, when the fixed value has not been successfully retrieved from the external device (or a correct fixed value has not been retrieved), the hardware diagnosis circuit 15 determines that an abnormality has been detected in the Ethernet interface IC 11d and thus outputs the log-recording prohibition signal to the log-recording circuit 16.

The log-recording circuit 16 records a flag to the fourth log-storing area M5 of the log-recording non-volatile memory 11c when the log-recording start signal S4 is input thereto. On the other hand, the log-recording circuit 16 does not record a flag to the log-recording non-volatile memory 11c when the log-recording prohibition signal is input thereto. Once the recording of the flag to the log-recording non-volatile memory 11c is completed or in a case where the log-recording prohibition signal is input, the log-recording circuit 16 outputs the log-recording completion signal S5 to the hardware diagnosis circuit 15. When the hardware diagnosis processing is completed for all of the hardware, the hardware diagnosis circuit 15 terminates the action of the controller.

Thereafter, the operator of the controller presses the startup button 17 since this controller has been shut down. When the first reset circuit 12 outputs the reset signal to the CPU 10 in response to this, the CPU 10 carries out restart processing for the controller. Subsequently, after restart, the CPU 10 accesses the first log-recording area M2, the second log-recording area M3, the third log-recording area M4, and the fourth log-recording area M5 of the log-recording non-volatile memory 11c and determines whether the flag is recorded in each of the recording areas, thereby being able to detect whether an abnormality has occurred in the respective hardware. In addition, in a case where it is detected that no abnormality has occurred in the hardware, a fact that the controller has shut down due to an abnormality in the CPU 10 can be detected.

The hardware diagnosis circuit 15 according to the embodiment carries out the hardware diagnosis processing on the respective hardware in the order of the log-recording non-volatile memory 11c, the operating memory 11a, the program-storing non-volatile memory 11b, and the Ethernet interface IC 11d. However, the hardware diagnosis circuit 15 is not limited thereto but may carry out the hardware diagnosis processing on the respective hardware in an order different from the above-mentioned order.

Meanwhile, the log-recording circuit 16 according to the embodiment records a result of the hardware diagnosis processing by whether to record a flag to the log-recording non-volatile memory 11c. However, the log-recording circuit 16 is not limited thereto but may record, for example, a log indicating a result of the hardware diagnosis processing to the log-recording non-volatile memory 11c.

In addition, in the embodiment, a result of abnormality detection in the hardware during the first log-recording processing and a result of the hardware diagnosis processing are recorded to the same storage (log-recording non-volatile memory 11c). However, a result of abnormality detection in the hardware during the first log-recording processing and a result of the hardware diagnosis processing may be separately recorded to different storages.

Furthermore, in the embodiment, a result of abnormality detection in the hardware during the first log-recording processing and a result of the hardware diagnosis processing are recorded to the storage within the controller (log-recording non-volatile memory 11c). However, a result of abnormality detection in the hardware during the first log-recording processing and a result of the hardware diagnosis processing may be recorded to a storage outside of the controller.

Next, the first log-recording processing by the controller according to the embodiment will be described with reference to FIG. 3. FIG. 3 is a flowchart illustrating an exemplary flow of the first log-recording processing by the controller according to the first embodiment.

In the embodiment, the CPU 10 carries out the startup processing and then starts control of the hardware once the reset signal is input thereto from the first reset circuit 12. Thereafter, the CPU 10 determines whether the interrupt signal S1 has been input thereto from the watch doc timer 13 (step S301).

When it is determined that the interrupt signal S1 has not been input from the watch doc timer 13 (step S301: No), the CPU 10 continues control of the hardware. On the other hand, when it is determined that the interrupt signal S1 has been input from the watch doc timer 13 (step S301: Yes), the CPU 10 carries out the first log-recording processing (step S302). Thereafter, the CPU 10 terminates the action of the controller.

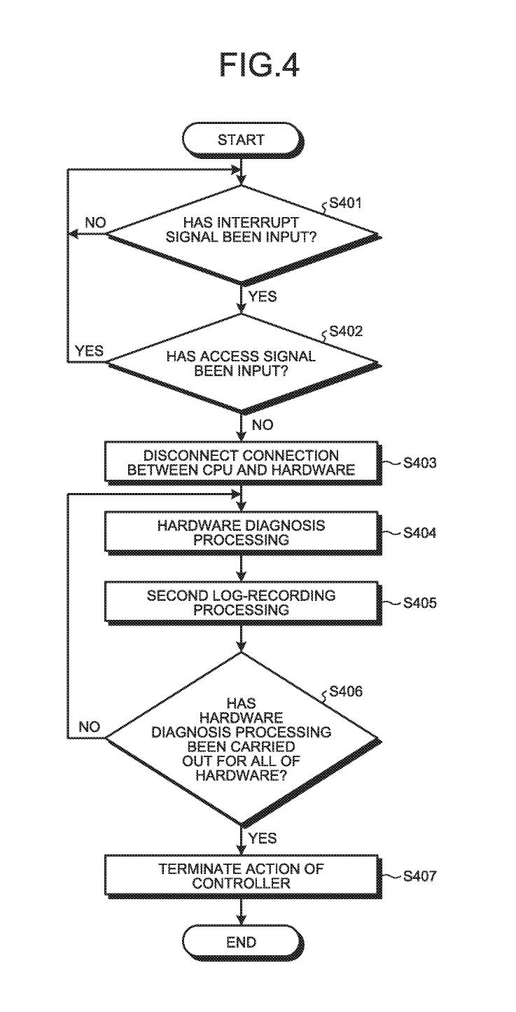

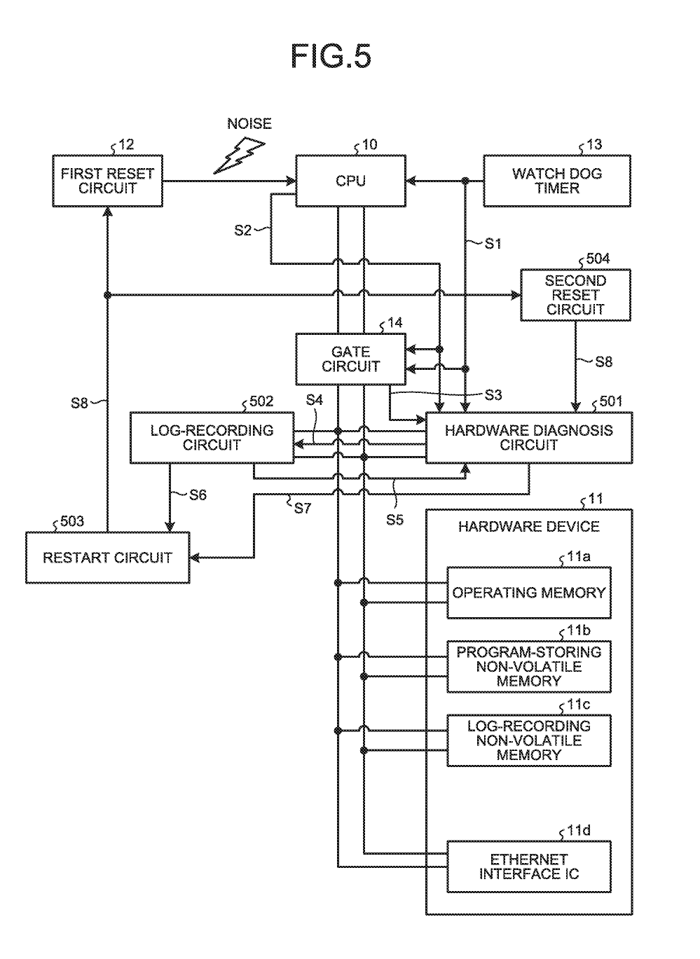

Next, a flow of the hardware diagnosis processing and the second log-recording processing by the controller according to the embodiment will be described with reference to FIG. 4. FIG. 4 is a flowchart illustrating an exemplary flow of the hardware diagnosis processing and the second log-recording processing by the controller according to the first embodiment.

In the embodiment, once control of the hardware is started by the CPU 10, the gate circuit 14 determines whether the interrupt signal S1 has been input thereto from the watch doc timer 13 (step S401). When it is determined that the interrupt signal S1 has not been input from the watch doc timer 13 (step S401: No), the gate circuit 14 returns to step S401 and determines again whether the interrupt signal S1 has been input thereto.

On the other hand, when the interrupt signal S1 is input from the watch doc timer 13 (step S401: Yes), the gate circuit 14 determines whether the access signal S2 has been input thereto from the CPU 10 (that is, whether the first log-recording processing is carried out by the CPU 10) (step S402). When the access signal S2 has been input from the CPU 10 (step S402: Yes), no abnormality occurs in the CPU 10 and the CPU 10 is carrying out the first log-recording processing. Accordingly, the gate circuit 14 returns to step S401 and determines again whether the interrupt signal S1 has been input thereto.

On the other hand, when the access signal S2 has not been input from the CPU 10 (step S402: No), the gate circuit 14 prohibits communication between the CPU 10 and the hardware via the data bus B1 and the address bus B2 to disconnect a connection between the CPU 10 and the hardware (step S403) and also outputs the gate-closed signal S3 to the hardware diagnosis circuit 15.

Once the gate-closed signal S3 is input to the hardware diagnosis circuit 15 from the gate circuit 14, the hardware diagnosis circuit 15 carries out the hardware diagnosis processing on the respective hardware in an order set in advance (step S404). Subsequently, the log-recording circuit 16 carries out the second log-recording processing to record, to the log-recording non-volatile memory 11c, a result of the hardware diagnosis processing that just has been carried out every time the hardware diagnosis processing is carried out on one hardware (step S405). The hardware diagnosis circuit 15 and the log-recording circuit 16 repeat the processing indicated by steps S404 and S405 until the hardware diagnosis processing is completed for all of the hardware (step S406: No). After the hardware diagnosis processing is all completed (step S406: Yes), the hardware diagnosis circuit 15 terminates the action of the controller (step S407).

As described above, the controller according to the first embodiment can locate a cause of an abnormality occurring within the controller by confirming information stored in the log-recording non-volatile memory 11c even in a case where the abnormality has occurred in the CPU 10.

### Second Embodiment

This embodiment indicates an example of enhancing an operating rate of the controller by causing the hardware to restart in a case where the hardware other than the CPU has no abnormality therein. In the following description, explanations of parts similar to those of the first embodiment will be omitted.

FIG. 5 is a block diagram illustrating an exemplary function configuration of a controller according to the second embodiment. As illustrated in FIG. 5, the controller according to the embodiment has a CPU 10, a hardware device 11, a first reset circuit 12, a watch doc timer 13, a gate circuit 14, a hardware diagnosis circuit 501, a log-recording circuit 502, a restart circuit 503, and a second reset circuit 504.

When a startup signal S8 is input to the second reset circuit 504 (an example of a reset unit) from the restart circuit 503 described later, the second reset circuit 504 outputs a reset signal instructing the execution of the startup processing to hardware included in the controller other than the CPU 10 (e.g., an operating memory 11a, a program-storing non-volatile memory 11b, a log-recording non-volatile memory 11c, and an Ethernet interface IC 11d). In addition, the first reset circuit 12 according to the embodiment outputs a reset signal instructing the execution of the startup processing to the CPU 10 when the startup signal S8 is input thereto from the restart circuit 503 described later.

The log-recording circuit 502 outputs a restart confirmation signal S6 indicating a result of the hardware diagnosis processing to the restart circuit 503 every time the second log-recording processing is carried out. Meanwhile, after the hardware diagnosis processing is completed for all of the hardware, the hardware diagnosis circuit 501 outputs, to the restart circuit 503, a hardware diagnosis processing completion signal S7 indicating that the hardware diagnosis processing has been completed.

Once the restart confirmation signal S6 is input to the restart circuit 503 (an example of a restart unit) from the log-recording circuit 502, the restart circuit 503 determines whether an abnormality has been detected in the hardware, on the basis of this restart confirmation signal S6. Thereafter, in a case where the restart circuit 503 determines that the hardware diagnosis processing completion signal S7 has been input thereto from the hardware diagnosis circuit 501 and no abnormality has been detected in the hardware, the restart circuit 503 outputs the startup signal S8 to the first reset circuit 12 and the second reset circuit 504 to restart the CPU 10 and the hardware. In other words, when determining that no abnormality has been detected in the hardware, the restart circuit 503 controls the first reset circuit 12 and the second reset circuit 504 such that the CPU 10 and the hardware are restarted. With this, the hardware can be restarted even in a case where an abnormality occurs in the CPU 10, whereby the operating rate of the controller can be enhanced.

On the other hand, when determining that an abnormality has been detected in the hardware, the restart circuit 503 does not output the startup signal S8. In other words, only in a case where no abnormality has been detected in the hardware, the restart circuit 503 controls the first reset circuit 12 and the second reset circuit 504 such that the CPU 10 and the hardware are restarted. In the embodiment, the restart circuit 503 controls the first reset circuit 12 and the second reset circuit 504 such that both of the CPU 10 and the hardware are restarted, in a case where no abnormality has been detected in the hardware. However, the restart circuit 503 is not limited thereto as long as the restart circuit 503 is of a type configured to restart at least the hardware. For example, when determining that no abnormality has been detected in the hardware, the restart circuit 503 outputs the reset signal only to the second reset circuit 504 to restart solely the hardware other than the CPU 10.

As described above, the controller according to the second embodiment can enhance the operating rates of the hardware other than the CPU 10.

As described thus far, according to the first and second embodiments, a cause of an abnormality occurring within the controller can be located by confirming information stored in the log-recording non-volatile memory 11c even in a case where the abnormality has occurred in the CPU 10.

In the embodiments, the first reset circuits 12, the watch doc timers 13, the gate circuits 14, the hardware diagnosis circuits 15 and 501, the log-recording circuits 16 and 502, the restart circuit 503, and the second reset circuit 504 included in the controllers according to the first and second embodiments are implemented using an integrated circuit such as a large scale integration (LSI) but not limited thereto. For example, the first reset circuits 12, the watch doc timers 13, the gate circuits 14, the hardware diagnosis circuits 15 and 501, the log-recording circuits 16 and 502, the restart circuit 503, and the second reset circuit 504 also can be implemented by a CPU other than the CPU 10 executing a program stored in a storage device.

Note that a program executed by the controller according to each of the embodiments is provided by being built into a read only memory (ROM) or the like in advance. In addition, the program executed by the controller according to each of the embodiments may be configured so as to be provided by being recorded in a recording medium readable by a computer, such as a CD-ROM, a flexible disk (FD), a CD-R, and a digital versatile disk (DVD), as a file in an installable format or in an executable format.

Furthermore, the program executed by the controller according to each of the embodiments may be configured so as to be saved and kept in a computer connected to a network such as the Internet such that the provision thereof is by way of download via the network. Alternatively, the program executed by the controller according to each of the embodiments may be configured so as to be provided or distributed via a network such as the Internet.

Some embodiments according to the invention have been described thus far. These embodiments are presented as examples and not intended to limit the scope of the invention. These novel embodiments can be carried out in other various modes and can be variously omitted, replaced, and modified without departing from the spirit of the invention. These embodiments and the modifications thereof are included in the scope and the spirit of the invention and also included in the scope of the invention disclosed in claims and the equivalents thereof.

What is claimed is:

1. An information processing device comprising:
a hardware;
a control unit that is communicably connected to the hardware and carries out startup processing of starting up in accordance with a first reset signal that has been input to the control unit from a first reset unit and first processing of detecting an abnormality in the hardware and then recording a result of abnormality detection in the hardware to a first storage;
a detector that carries out processing of detecting an abnormality in the control unit and, in a case where an abnormality is detected in the control unit, causes the control unit to carry out the first processing;
a disconnection unit that disconnects a connection between the hardware and the control unit in a case where an abnormality is detected in the control unit and the first processing is not carried out by the control unit;
a diagnosis unit that carries out second processing of detecting an abnormality in the hardware in a case where the connection between the hardware and the control unit is disconnected; and
a processor that carries out third processing of recording a result of the second processing to a second storage.

2. The information processing device according to claim 1, further comprising:
a second reset unit that restarts the hardware; and
a restart unit that controls the second reset unit such that the hardware is restarted in a case where no abnormality has been detected in the hardware during the second processing.
